(19) United States
(12) Patent Application Publication
(10) Pub. No.: US 2009/0315861 A1
(43) Pub. Date: Dec. 24, 2009

(54) INTERACTIVE WHITEBOARD SYSTEM

(75) Inventors: CHAO ZHANG, Tempe, AZ (US); Bin HU, Chandler, AZ (US); Shinhwa LI, Chandler, AZ (US); Jen-Lung David TAI, Scottsdale, AZ (US)

Correspondence Address: MICHAEL WINFIELD GOLTRY, 4000 N. CENTRAL AVENUE, SUITE 1220, PHOENIX, AZ, 85012, US

(73) Assignee: INNOVATIVE MATERIAL SOLUTIONS, INC., GLENDALE, AZ (US)

(21) Appl. No.: 12/474,901

(22) Filed: May 29, 2009

Related U.S. Application Data
(60) Provisional application No. 61/073,667, filed on Jun. 18, 2008.

(51) Int. Cl. G06F 3/033

(52) U.S. Cl. 345/179

(57) ABSTRACT

An interactive whiteboard system includes a combination electrical writable and dry erase marker, an interactive whiteboard to receive writing on the interactive whiteboard with the combination electrical writable and dry erase marker, and a computer operatively coupled to the interactive whiteboard to capture writing on the interactive whiteboard with the combination electrical writable and dry erase marker.

### CROSS-REFERENCE TO RELATED APPLICATION

This application claims the benefit of U.S. Provisional Patent Application Ser. No. 61/073,667, filed 18 Jun. 2008.

### FIELD OF THE INVENTION

The present invention relates to electronic whiteboards.

### BACKGROUND OF THE INVENTION

A conventional non-interactive or dry-erase whiteboard is formed with a glossy surface onto which non-permanent markings are applied. Whiteboards operate like chalkboards in that markings temporarily adhere to the surface of the board and are easily wiped away. Instead of using chalk to make the markings as with chalkboards, a dry-erase marker containing dry-erase or removable ink is used, which is easily wiped away with a cloth or eraser. As a replacement to conventional chalkboards, whiteboards are advantageous because they eliminate the use of chalk and the formation of chalk dust that comes from using chalk and erasing chalk, and can accept writing from dry erase markers have a wide range of colors. However, whiteboards are more expensive than blackboards, are suitable for use only with specialized whiteboard markers, and can cause contrast problems for people with vision impairment.

The shortcomings of blackboards and whiteboards have been addressed by skilled artisans through the development of interactive whiteboards. A conventional interactive whiteboard is a large interactive display that connects to a computer and a projector. The projector projects the computers desktop onto the surface of the board, where users control the computer using a pen, finger, or other device. The board is normally mounted on a wall or supported by a floor stand. A typical interactive whiteboard requires the use of a projector, which is an expensive piece of equipment, and cannot be used with a conventional non-interactive whiteboard.

### SUMMARY OF THE INVENTION

According to the principle of the invention, an interactive whiteboard system includes a combination electrical writable and dry erase marker, an interactive whiteboard to receive writing on the interactive whiteboard with the combination electrical writable and dry erase marker, and a computer operatively coupled to the interactive whiteboard to capture writing on the interactive whiteboard with the combination electrical writable and dry erase marker. A combination electrical erasable and dry erase eraser to erase writing on the interactive whiteboard with the combination electrical writable and dry erase marker also forms part of the system, and the computer is operatively coupled to the interactive whiteboard to erase captured writing corresponding to writing erased from the interactive whiteboard with the combination electrical erasable and dry erase eraser. A monitor operatively coupled to the computer to display writing captured by the computer from the interactive whiteboard. A storage device is operatively coupled to the computer to receive and store writing captured by the computer.

According to the principle of the invention, an interactive whiteboard system includes a marker, an interactive whiteboard, and a computer. The marker includes a working tip having an outer end, a dry-erase marking structure having a first working end formed at the outer end of the working tip, and a stylus having a second working end formed at the outer end of the working tip. The interactive whiteboard is to receive writing on the interactive whiteboard with the first working end of the dry-erase marking structure formed in the working tip of the marker, and the computer is operatively coupled to the interactive whiteboard to capture writing on the interactive whiteboard with the second working end of the stylus formed in the outer end of the working tip. The system also includes a dry erase eraser to erase writing on the interactive whiteboard. The dry erase eraser is formed with a processor operatively coupled to probes, and the computer is operatively coupled to the interactive whiteboard to erase captured writing corresponding to writing erased from the interactive whiteboard with the dry erase eraser in response to interaction between the interactive whiteboard and the probes formed in the dry erase eraser in erasing writing from the interactive whiteboard with the dry erase eraser. A monitor is operatively coupled to the computer to display writing captured by the computer from the interactive whiteboard. A storage device is operatively coupled to the computer to receive and store captured writing.

According to the principle of the invention, an interactive whiteboard system includes a combination electrical writable and dry erase marker, an interactive whiteboard to receive writing on the interactive whiteboard with the combination electrical writable and dry erase marker, and a processor operatively coupled to a storage device, the processor operatively coupled to the interactive whiteboard to capture writing on the interactive whiteboard with the combination electrical writable and dry erase marker and store the captured writing in the storage device. The system also includes a combination electrical erasable and dry erase eraser to erase writing on the interactive whiteboard with the combination electrical writable and dry erase marker, and the processor operatively coupled to the interactive whiteboard to erase captured writing corresponding to writing erased from the interactive whiteboard with the combination electrical erasable and dry erase eraser. A display is operatively coupled to the processor to display writing captured by the computer from the interactive whiteboard.

Consistent with the foregoing summary of preferred embodiments, and the ensuing detailed description, which are to be taken together, the invention also contemplates associated apparatus and method embodiments.

### BRIEF DESCRIPTION OF THE DRAWINGS

Referring to the drawings:

FIG. 1 is a schematic representation of an interactive whiteboard system constructed and arranged in accordance with the principle of the invention;

FIG. 2 is an enlarged perspective view of a combination electrical writable and dry erase marker of the system of FIG. 1, the marker constructed and arranged in accordance with the principle of the invention;

FIG. 3 is an enlarged, fragmented, schematic view of the marker of FIG. 1;

FIG. 4 is a schematic representation of a combination electrical erasable and dry erase eraser of constructed and arranged in accordance with the principle of the invention, the eraser forming part of the system of FIG. 1;

FIG. 5 is a schematic representation of the system of FIG. 1; and

FIG. 6 is a schematic representation of an alternate embodiment of an interactive whiteboard system constructed and arranged in accordance with the principle of the invention.

### DETAILED DESCRIPTION OF PREFERRED EMBODIMENTS

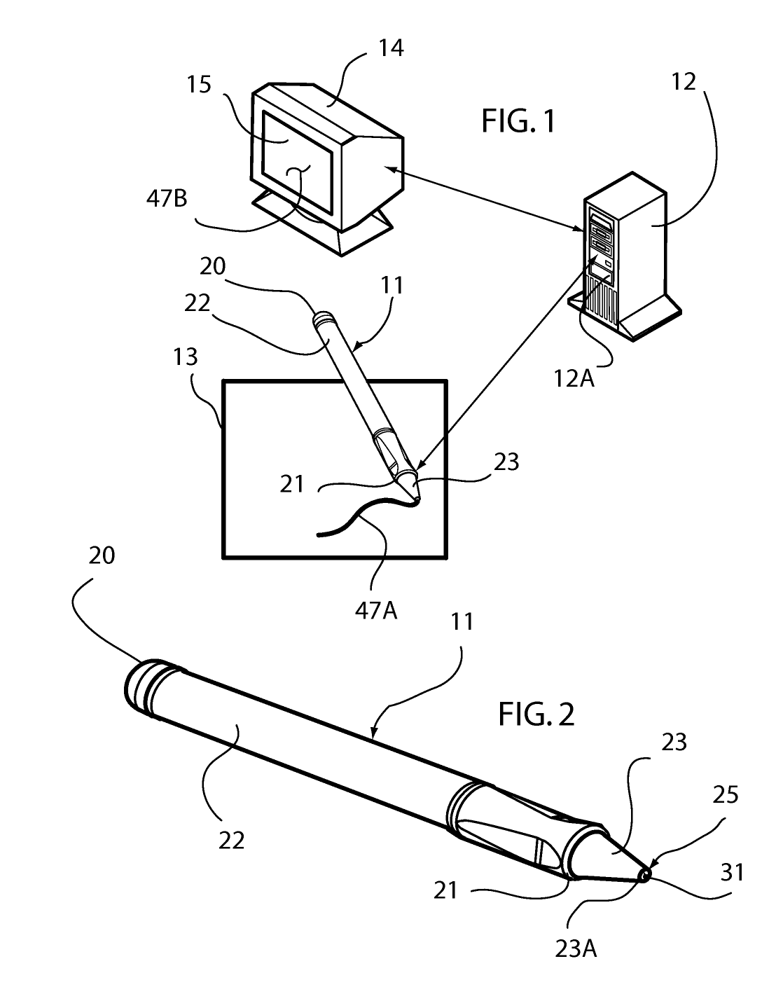

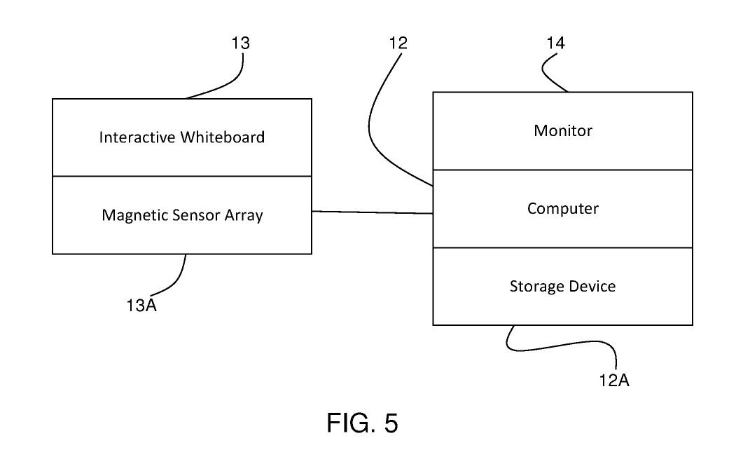

Turning now to the drawings, in which like reference characters indicate corresponding elements throughout the several views, attention is first directed to FIG. 1, in which there is seen a schematic representation of an interactive whiteboard system 10 constructed and arranged in accordance with the principle of the invention including a combination electrical writable and dry erase marker 11, and, as also illustrated schematically in FIG. 5, a computer 12 operatively coupled in signal communication with conventional wired or wireless connections to an interactive whiteboard 13 and to a monitor 14 formed with a display 15. Interactive whiteboard 13 is to receive writing with marker 11, and computer 12 is operatively coupled to interactive whiteboard 13 to capture writing on interactive whiteboard 13 with marker 11. Monitor 14 is operatively coupled to computer 12 to display on display 15 writing captured by computer 12 from interactive whiteboard 13. Computer 12 has a storage device denoted generally at 12A in FIG. 1, which is operatively coupled to computer 12 to receive and store writing captured by computer 12 from interactive whiteboard 13. In the present embodiment, computer 12 is a conventional well-known personal computer, monitor 14 is a conventional computer monitor, and storage device 12A is a hard drive of computer 12 being exemplary of a mass storage device. If desired, computer storage 12A may be a removable media drive, such as a removable compact disc, flash drive, or the like.

Whiteboard 13 and marker 11 together incorporate conventional and well-known electromagnetic sensing technology that captures writing applied to whiteboard 13 with marker 11 and sends the captured writing to computer 12 via the operative coupling between whiteboard 13 and computer 12 for storage in computer 12, such as in storage device 12A of computer 12 or other electronic storage or memory of or associated with computer 12. Again with reference to FIG. 1, computer 12 is operatively coupled in signal communication to monitor 14, whereby the captured writing between marker 11 and whiteboard 13 is accurately displayed on display 15 of monitor 14. As with conventional interactive whiteboards, a magnetic sensor array 13A referenced in FIG. 5 is formed in whiteboard 13, which detects a signal from a corresponding electronic stylus 25, illustrated in FIG. 2, formed in marker 11, whereby a position signal formed between stylus 25 and magnetic sensor array 13A formed in whiteboard 13 is transferred to computer 12, which transfers display information to display 15 of monitor 14. In prior art interactive whiteboard systems, a projector is provided that projects the computer's desktop displayed on display 15 of monitor 14 onto the writing surface of whiteboard 13 to allow onlookers to see the writing on whiteboard 13 as it takes place, in which whiteboard 13 is mounted at an elevated location, such as on a wall or stand. However, the invention eliminates the need for a projector.

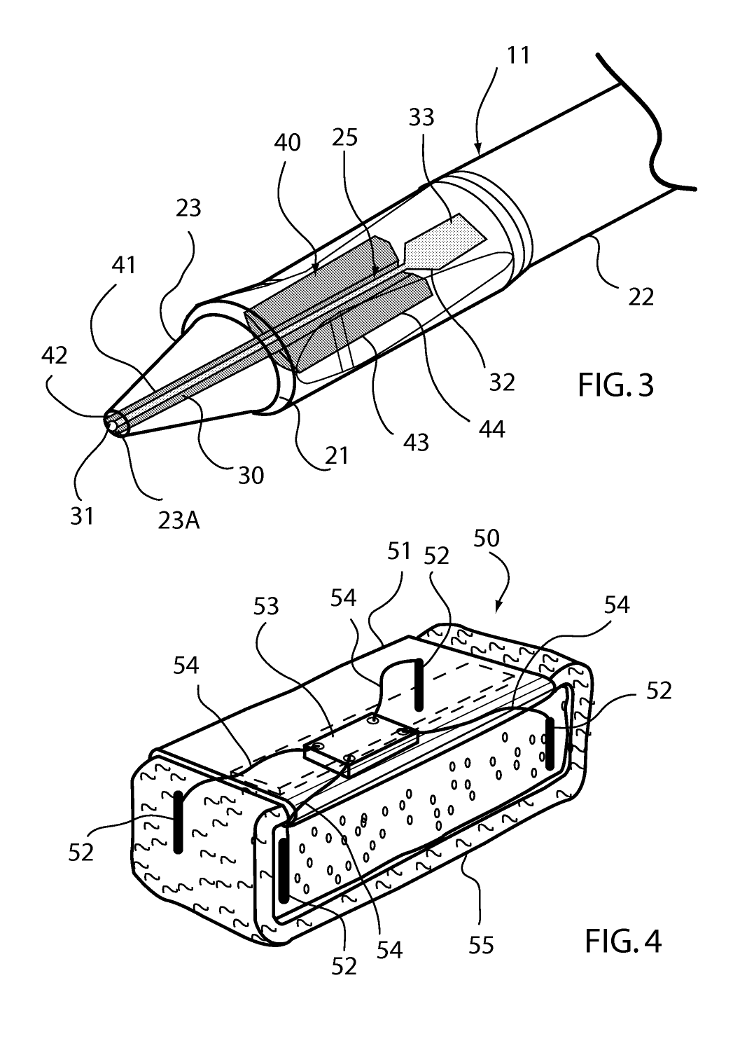

Referencing FIG. 2, marker 14 is elongate and consists of an elongate housing or support 19 having opposed proximal and distal ends 20 and 21. A handle 22 is formed adjacent to proximal end 20, and a working tip 23 of marker 14 is formed in distal end 21, which is also illustrated in FIG. 3. Working tip 23 has an extreme outer end denoted at 23A. Referencing FIG. 3, which is an enlarged, fragmented, schematic view of marker 11 of FIG. 1, stylus 25 is formed in marker 11, which consists of an electronic probe 30 having a working end 31 formed at outer end 23A of working tip 23 of marker 11, and extends inwardly into the interior of marker 11 through working tip 23 toward handle 22 to an inner end 32 operatively coupled to conventional electronics 33 to control the conventional operation of stylus 25. Working end 31 of stylus 25 is positioned at outer end 23A of working tip 23 to facilitate an operative application of working tip 23 of stylus 25 with respect to whiteboard 13 to facilitate an operative coupling between stylus 25 and magnetic sensor array 13A (FIG. 5) formed in whiteboard 13 to provide the normal operation of stylus 25 in conjunction with the magnetic sensor array formed in whiteboard 13.

With continuous reference to FIG. 3, a dry-eraser ink marking structure 40 is formed in distal end 21 and working tip 23 of marker 11. Marking structure 40 consists of an elongate conduit or wick 41 having a working end 42 formed at outer end 23A of working tip 23 at outer end 31 of electronic probe 30, and extends inwardly into working tip 23 into the interior of marker 11 toward handle 22 to an inner end 43 coupled to receive dry-erase ink from a dry-erase ink reservoir 44 formed in marker 11 and conduct the ink from reservoir 44 to working end 42. In this embodiment, electronic probe 30 is encircled by wick 41, and extends through wick 41 from working end 31 of electronic probe 30 at working end 42 of wick 41 and through reservoir 44 to inner end 32 of electronic probe 30 which is operatively coupled to electronics 33 formed outboard of reservoir 44. Electronics 33 forms part of stylus 25, which is conventional and well known. Working end 42 of wick 41 of marking structure 40 is located at outer end 23A of working tip 23 to facilitate an operative application of working end 42 of wick 41 of marking structure 40 against whiteboard 13 to facilitate normal application of removable ink markings onto whiteboard 13 from the application of working end 42 against whiteboard 13.

In operation and with reference in relevant part to FIGS. 1 and 3, handle 22 of marker 11 is taken up by hand and outer end 23A of working tip 23 of marker 11 is applied to the surface of whiteboard 13 bringing working end 42 into engagement with the surface of whiteboard 13 and working end 31 of electronic probe 30 into an operative relationship or coupling with magnetic sensor array 13A (FIG. 5) formed in whiteboard 13. Normally, working end 31 of electronic probe 30 will engage the surface of whiteboard 13. It is to be emphasized that working end 31 of stylus 25 is formed at the same region as working end 42 of marking structure 40 at outer end 23A of working tip 23 of marker 11. At this point, the user wielding marker 11 proceeds to write in the normal manner moving working ends 31 and 42 of stylus 25 and marking structure 40, respectively, across the surface of whiteboard 13. As working ends 31 and 42 are drawn across the surface of whiteboard 13, working end 42 applies dry-erase or removable ink markings, such as dry-erase marking 47A, to the surface of whiteboard 13, and the operative relationship or coupling between stylus 25 and magnetic sensor array 13A (FIG. 5) formed in whiteboard 13, and the operative coupling between magnetic sensor array 13A of whiteboard 13 and computer 12, captures writing applied to whiteboard 13 with marker 11 and stores the writing into computer 12 storage as electronic data in the form of electronic markings. Typically, the electronic markings are stored in storage device 12A of computer 12. The captured electronic markings sent to computer 12 for storage may be displayed on display 15 of monitor 14 if desired, such as marking 47B corresponding to marking 47A applied to whiteboard 13 as seen in FIG. 1.

Because working end 31 of stylus 25 is formed at the same region as working end 42 of marking structure 40 at outer end 23A of working tip 23 of marker 11, the removable ink markings, such as markings 47A, made on the surface of whiteboard 13 by working end 42 of marking structure 40 conform to the electronic markings captured by the electromagnetic sensing technology comprising stylus 25 and magnetic sensor array 13A (FIG. 5) formed in whiteboard 13 and stored in computer 12 storage, in accordance with the principle of the invention. Moreover, because the removable ink markings made on the surface of whiteboard 13 by working end 42 of marking structure 40 conform to the electronic markings captured by the electromagnetic sensing technology comprising stylus 25 and magnetic sensor array 13A (FIG. 5) formed in whiteboard 13 and stored in computer 12, onlookers viewing whiteboard 13 may see and understand the dry-erase or removable ink markings applied to whiteboard 13 by working end 42 of marking structure 40 which are captured as substantially identical electronic markings in computer 12, such as in storage device 12A of computer 12, the electromagnetic sensing technology formed in marker 11 and whiteboard 13 thereby obviating any need for a projector to project electronic markings from a projector as with prior art interactive whiteboards. In sum, the physical writing applied to the surface of whiteboard 13 with marker 11 is substantially the same as the electronic markings captured by the electromagnetic sensing technology formed in marker 11 and whiteboard 13, in accordance with the principle of the invention.

Reference is now made to FIG. 4, which is a schematic representation of a combination electrical erasable and dry erase eraser 50 to erase writing on whiteboard 13 with marker 11. With additional reference to FIG. 1, computer 12 is operatively coupled to whiteboard 13 to also erase from computer 12 captured writing corresponding to writing erased from whiteboard 13 with eraser 50. Eraser 50 is constructed and arranged in accordance with the principle of the invention, and forms part of system 10. Eraser 50 consists of an eraser body 51 formed of conventional dry-eraser material commonly used with conventional whiteboards. A stylus system is formed in eraser 50. In this specific example, the stylus system in eraser 50 is formed by a plurality of electronic probes 52 formed in eraser body 51, which are operatively coupled to an electronic device or electronics 53 also formed in eraser body 51. Electronics 53 control the operation of electronic probes 52. In this example, electrical wiring 54 formed in eraser body 51 is used to operatively couple electronic probes 52 to electronics 53. Eraser body 51 defines an erasing surface or face 55 having an erasing footprint, and electronic probes 52 are formed at spaced intervals across the footprint defined by eraser face 55. Electronic probes 52 formed in eraser body 51 form an electronic erasing footprint conforming substantially to the erasing footprint defined by erasing face 55.

Eraser 50 is used to erase dry-erase or removable ink markings applied to the surface of whiteboard 13 by working end 42 of marking structure 40, and to concurrently erase the matching electronic markings captured by the electromagnetic sensing technology formed in whiteboard 13 and marker 11, in accordance with the principle of the invention. In the operation of eraser 50, eraser 50 is taken up by hand and erasing face 55 is applied to the surface of whiteboard 13 bringing the erasing face into engagement with the surface of whiteboard 13 and electronic probes 52 forming the stylus system of eraser 50 into an operative relationship or coupling with magnetic sensor array 13A (FIG. 5) formed in whiteboard 13. At this point, the user wielding eraser 50 proceeds to erase the dry-erase or removable ink markings made on the surface of whiteboard 13 by rubbing erasing face 55 over the dry-erase or removable ink markings, whereby the electronic erasing footprint formed by electronic probes 52 operatively interacts with the magnetic sensor array formed in whiteboard 13 erasing any previously captured matching or corresponding electronic markings from computer 12 within the electronic erasing footprint formed by electronic probes 52, in accordance with the principle of the invention. Software instructions executed by computer 12 cooperate with the electromagnetic sensing technology formed by stylus 25 and magnetic sensor array 13A (FIG. 5) in whiteboard 13 to capture electronic markings made by the application of working end 31 of stylus 25 across the surface of whiteboard 13, and cooperates with the electromagnetic sensing technology formed by the stylus system in eraser 50 and magnetic sensor array 13A (FIG. 5) formed in whiteboard 13 to erase electronic markings made by the previous application of working end 31 of stylus across the surface of whiteboard 13 as erasing face 55 of eraser 50 is moved across the dry-erase or removable ink markings previously applied by working end 42 of marking structure 40, in accordance with the principle of the invention.

In sum, the system disclosed herein provides stylus 25 in a dry erase marker 11 such that dry-erase or removable ink markings will show on whiteboard 13 while the captured electronic markings are sent to computer 12 for storage, and, if desired, displayed on display 15 of monitor 14. Eraser 50 is used to wipe away the dry-erase or removable ink markings applied to whiteboard 13 with marker 11, whereby the stylus system formed in eraser 50 erases the same electronic markings from computer 12, in accordance with the principle of the invention. Because the writing and erasing on whiteboard 13 is substantially matched with the display on display 15 of monitor 14, there is no need for a projector to apply imagery of the electronic markings onto the whiteboard. Whiteboard 13 can be double sided to provide identical function on each of the opposed sides, if desired. Moreover, system 10 can be provided with an IP address to provide system 10 with enhanced functionality, such as color management, brush paint, etc.

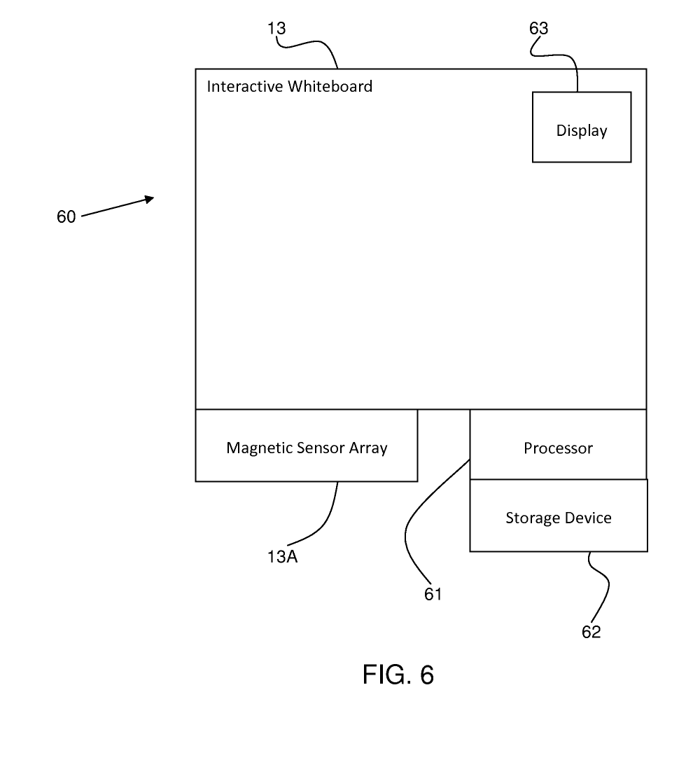

Reference is now made to FIG. 6, which is a schematic representation of an interactive whiteboard system 60 constructed and arranged in accordance with an alternate embodiment of the invention. In common with the previous embodiment denoted at 10, system 60 shares interactive whiteboard 13 including magnetic sensor array 13A. System 60 in FIG. 6 is an integrated system, additionally including a built in central processing unit or processor 61, a built in storage device 62, and a built in display 63, such that system 60 is an integrated, self-contained system. Interactive whiteboard 13 including magnetic sensor array 13A, central processing unit or processor 61, storage device 62, and a built in display 63 are operatively coupled together with conventional electrical wiring an circuitry (not shown), such that system 60 is an integrated, self-contained system. Display 63 is a liquid crystal display, plasma display, or other form of conventional electronic display, and is integrated into whiteboard 13. By way of example, display 63 is formed in the upper right corner if whiteboard 13, but may be formed elsewhere if desired. Processor 61 is a conventional, and is operatively coupled in signal communication to storage device 62 and display 63 with conventional wiring or wireless interconnections. Interactive whiteboard 13 is to receive writing with marker 11 (FIGS. 1, 2, and 3) as described in system 10, and processor 61 is operatively coupled to interactive whiteboard 13 to capture writing on interactive whiteboard 13 with marker 11 and store the captured writing in storage device 62. Display 63 is operatively coupled to processor 61 to display writing captured by processor 61 from interactive whiteboard 13, and storage device 62 is operatively coupled to processor 61 to receive and store writing captured by processor 61 from interactive whiteboard 13. If desired, system 60 can be configured with internet connectivity to allow captured writing to be communicated through an internet, such as by email, etc.

The invention has been described above with reference to preferred embodiments. However, those skilled in the art will recognize that changes and modifications may be made to the embodiments without departing from the nature and scope of the invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. An interactive whiteboard system, comprising:
a combination electrical writable and dry erase marker;
an interactive whiteboard to receive writing on the interactive whiteboard with the combination electrical writable and dry erase marker; and
a computer operatively coupled to the interactive whiteboard to capture writing on the interactive whiteboard with the combination electrical writable and dry erase marker.

2. The interactive whiteboard system according to claim 1, further comprising:
a combination electrical erasable and dry erase eraser to erase writing on the interactive whiteboard with the combination electrical writable and dry erase marker; and
the computer operatively coupled to the interactive whiteboard to erase captured writing corresponding to writing erased from the interactive whiteboard with the combination electrical erasable and dry erase eraser.

3. The interactive whiteboard system according to claim 1, further comprising a monitor operatively coupled to the computer to display writing captured by the computer from the interactive whiteboard.

4. The interactive whiteboard system according to claim 1, further comprising a storage device operatively coupled to the computer to receive and store writing captured by the computer.

5. An interactive whiteboard system, comprising:
a marker including a working tip having an outer end, a dry-erase marking structure having a first working end formed at the outer end of the working tip, and a stylus having a second working end formed at the outer end of the working tip;
an interactive whiteboard to receive writing on the interactive whiteboard with the first working end of the dry-erase marking structure formed in the working tip of the marker;
a computer operatively coupled to the interactive whiteboard to capture writing on the interactive whiteboard with the second working end of the stylus formed in the outer end of the working tip.

6. The interactive whiteboard system according to claim 5, further comprising:
a dry erase eraser to erase writing on the interactive whiteboard;
a processor operatively coupled to probes formed in the dry erase eraser; and
the computer operatively coupled to the interactive whiteboard to erase captured writing corresponding to writing erased from the interactive whiteboard with the dry erase eraser in response to interaction between the interactive whiteboard and the probes formed in the dry erase eraser in erasing writing from the interactive whiteboard with the dry erase eraser.

7. The interactive whiteboard system according to claim 5, further comprising a monitor operatively coupled to the computer to display writing captured by the computer from the interactive whiteboard.

8. The interactive whiteboard system according to claim 5, further comprising a storage device operatively coupled to the computer to receive and store captured writing.

9. An interactive whiteboard system, comprising:
a combination electrical writable and dry erase marker;
an interactive whiteboard to receive writing on the interactive whiteboard with the combination electrical writable and dry erase marker; and
a processor operatively coupled to a storage device, the processor operatively coupled to the interactive whiteboard to capture writing on the interactive whiteboard with the combination electrical writable and dry erase marker and store the captured writing in the storage device.

10. The interactive whiteboard system according to claim 9, further comprising:
a combination electrical erasable and dry erase eraser to erase writing on the interactive whiteboard with the combination electrical writable and dry erase marker; and
the processor operatively coupled to the interactive whiteboard to erase captured writing corresponding to writing erased from the interactive whiteboard with the combination electrical erasable and dry erase eraser.

11. The interactive whiteboard system according to claim 9, further comprising a display operatively coupled to the processor to display writing captured by the computer from the interactive whiteboard.
